(19) United States
(12) Patent Application Publication
(10) Pub. No.: US 2009/0210838 A1
(43) Pub. Date: Aug. 20, 2009

(54) INTERPOLATION DISTANCE FOR LAYOUT DESING DATA CORRECTION MODEL

(76) Inventor: Mohamed Al-Imam, Cairo (EG)

Correspondence Address: MENTOR GRAPHICS CORP.;PATENT GROUP, 8005 SW BOECKMAN ROAD, WILSONVILLE, OR, 97070-7777, US

(21) Appl. No.: 12/212,642

(22) Filed: Sep. 17, 2008

Related U.S. Application Data
(60) Provisional application No. 60/973,096, filed on Sep. 17, 2007.

(51) Int. Cl. G06F 17/50

(52) U.S. Cl. 716/5

(57) ABSTRACT

Various implementations of the present invention provide a method of determining is a optical proximity correction process model sufficiently covered the layout design. More particularly, various implementations of the invention provide a method for interpolating between test pattern features relative to layout design features under test.

### RELATED APPLICATIONS

This application claims priority under 35 U.S.C. § 119(e) to U.S. Provisional Patent Application No. 60/973,096 entitled “Safe Interpolation Distance For VT5 Resist Model” filed on Sep. 17, 2008, and naming Walid Tawfic et al. as inventors, which application is incorporated entirely herein by reference.

### FIELD OF THE INVENTION

The invention relates to the field of photolithographic processing. More particularly, various aspects of the invention relate to increasing the coverage of models employed in the optical proximity correction (OPC) process.

### BACKGROUND OF THE INVENTION

Electronic circuits, such as integrated microcircuits, are used in a variety of products, from automobiles to microwaves to personal computers. Designing and fabricating microcircuit devices typically involves many steps, sometimes referred to as the “design flow.” The particular steps of a design flow often are dependent upon the type of microcircuit, its complexity, the design team, and the microcircuit fabricator or foundry that will manufacture the microcircuit. Typically, software and hardware “tools” verify the design at various stages of the design flow by running software simulators and/or hardware emulators. These steps aid in the discovery of errors in the design, and allow the designers and engineers to correct or otherwise improve the design. These various microcircuits are often referred to as integrated circuits (IC's).

Several steps are common to most design flows. Initially, the specification for a new circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that it will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This device design generally corresponds to the level of representation displayed in conventional circuit diagrams. The relationships between the electronic devices are analyzed, to confirm that the circuit described by the device design will correctly perform the desired functions. This analysis is sometimes referred to as “formal verification.” Additionally, preliminary timing estimates for portions of the circuit are often made at this stage, using an assumed characteristic speed for each device, and incorporated into the verification process.

Once the components and their interconnections are established, the design is again transformed, this time into a physical design that describes specific geometric elements. This type of design often is referred to as a “layout” design. The geometric elements, which typically are polygons, define the shapes that will be created in various layers of material to manufacture the circuit. Typically, a designer will select groups of geometric elements representing circuit device components (e.g., contacts, channels, gates, etc.) and place them in a design area. These groups of geometric elements may be custom designed, selected from a library of previously-created designs, or some combination of both. Lines are then routed between the geometric elements, which will form the wiring used to interconnect the electronic devices. Layout tools (often referred to as “place and route” tools), such as Mentor Graphics' IC Station or Cadence's Virtuoso, are commonly used for both of these tasks.

IC layout descriptions can be provided in many different formats. The Graphic Data System II (GDSII) format is a popular format for transferring and archiving two-dimensional graphical IC layout data. Among other features, it contains a hierarchy of structures, each structure containing layout elements (e.g., polygons, paths or poly-lines, circles and textboxes). Other formats include an open source format named Open Access, Milkyway by Synopsys, Inc., EDDM by Mentor Graphics, Inc., and the more recent Open Artwork System Interchange Standard (OASIS) proposed by Semiconductor Equipment and Materials International (SEMI). These various industry formats are used to define the geometrical information in IC layout designs that are employed to manufacture integrated circuits. Once the microcircuit device design is finalized, the layout portion of the design can be used by fabrication tools to manufacturer the device using a photolithographic process.

There are many different fabrication processes for manufacturing a circuit, but most processes include a series of steps that deposit layers of different materials on a substrate, expose specific portions of each layer to radiation, and then etch the exposed (or non-exposed) portions of the layer away. For example, a simple semiconductor device component could be manufactured by the following steps. First, a positive type epitaxial layer is grown on a silicon substrate through chemical vapor deposition. Next, a nitride layer is deposited over the epitaxial layer. Then specific areas of the nitride layer are exposed to radiation, and the exposed areas are etched away, leaving behind exposed areas on the epitaxial layer, (i.e., areas no longer covered by the nitride layer). The exposed areas then are subjected to a diffusion or ion implantation process, causing dopants, for example phosphorus, to enter the exposed epitaxial layer and form charged wells. This process of depositing layers of material on the substrate or subsequent material layers, and then exposing specific patterns to radiation, etching, and dopants or other diffusion materials, is repeated a number of times, allowing the different physical layers of the circuit to be manufactured.

Each time that a layer of material is exposed to radiation, a mask must be created to expose only the desired areas to the radiation, and to protect the other areas from exposure. The mask is created from circuit layout data. That is, the geometric elements described in layout design data define the relative locations or areas of the circuit device that will be exposed to radiation through the mask. A mask or reticle writing tool is used to create the mask or reticle based upon the layout design data, after which the mask can be used in a photolithographic process. The image created in the mask is often referred to as the intended or target image, while the image created on the substrate, by employing the mask in the photolithographic process is referred to as the printed image.

As designers and manufacturers continue to increase the number of circuit components in a given area and/or shrink the size of circuit components, the shapes reproduced on the substrate (and thus the shapes in the mask) become smaller and are placed closer together. This reduction in feature size increases the difficulty of faithfully reproducing the image intended by the layout design onto the substrate. Adding to the difficulty associated with increasingly smaller feature size is the diffractive effects of light. As light illuminates the mask, the transmitted light diffracts at different angles in different regions of the mask. These effects often result in defects where the intended image is not accurately “printed” onto the substrate during the photolithographic process, creating flaws in the manufactured device.

To address this problem, one or more resolution enhancement techniques are often employed to improve the resolution of the image that the mask forms on the substrate during the photolithographic process. Examples of various resolution enhancement techniques are discussed in “Resolution Enhancement Technology: The Past, the Present, and Extensions for the Future,” Frank M. Schellenberg, Optical Microlithography XVII, edited by Bruce W. Smith, Proceedings of SPIE Vol. 5377, which article is incorporated entirely herein by reference. One of these techniques, radiation amplitude control, is often facilitated by modifying the layout design data employed to create the lithographic mask. One way to implement this technique, for example, is to adjust the edges of the geometric elements in the layout design so that the mask created from the modified layout data will control the radiation amplitude in a desired way during a lithographic process. The process of modifying the layout design data in this manner is often referred to as “optical proximity correction” or “optical process correction” (OPC).

As previously noted, a layout design is made up of a variety of geometric elements, which typically are polygons. In a conventional optical proximity correction process, the edges of these polygons are fragmented. More particularly, the individual edges of each polygon are divided into smaller sections, often referred to as edge segments or edge fragments. The size of the fragments and the particular edges to be fragmented are dependent upon parameters of the optical proximity correction process. The fragmenting of edges facilitates the optical proximity correction process by allowing the edge segments to be rearranged or edited to realize the desired modifications. Additionally, geometric features that will increase the fidelity of the photolithographic process may be added to the design by moving or displacing the fragments. For example, some optical proximity correction processes will reconfigure the edge segments of a polygon to create serifs at one or more corners.

Optical proximity correction is an iterative process. That is, the lithographic process that will be used to manufacture the integrated circuit is simulated to determine if the simulated printed image matches the intended printed image. Modifications are made to the layout design based upon the simulation results, and the lithograph process is simulated again. When the simulated printed image cannot be substantially improved by further displacement of the edge segments, it is often said that the optical proximity correction process has converged. This process of simulation, modification, and simulation is repeated until the simulated printed image significantly corresponds to the intended printed image, or until the optical proximity correction process has converged.

Layout designs can be very large. For example, one layout data file for a single layer of a field programmable gate array may be approximately 58 gigabytes. Accordingly, performing even a single iteration of an optical proximity correction process on a design is computationally intensive. Repeating the optical proximity correction process until the simulated printed image matches the intended printed image, or until the optical proximity process has converged, only adds to the time required to finalize the layout design. Often, it can take as many as eight iterations for an optical proximity correction process to converge. Due to the number of iterations of optical proximity correction required and the complexity and size of modern layout designs, even when employing advanced computer processing techniques, the time required to perform optical proximity correction is often measured in days.

After a microcircuit layout design has been modified by an optical proximity correction process and the edge segments within the layout design displaced, the adjusted microcircuit layout design must be again verified. The adjusted layout design is verified to ensure that the adjusted layout complies with the various design and manufacturing constraints the device is subject to. In many cases, especially in cases involving new designs and or manufacturing processes, the adjusted layout design may need to be further adjusted to resolve any anomalies detected by the verification process. Accordingly, an adjusted microcircuit layout design may be further adjusted by a subsequent optical proximity correction process. The need to perform further optical proximity correction processes on a layout design increases the development time of a device.

### SUMMARY OF THE INVENTION

Aspects of the present invention relate to techniques for reducing the number of iteration required for an optical proximity correction process to converge upon a suitable solution.

Various implementations of the present invention provide a method of determining is a optical proximity correction process model sufficiently covered the layout design. More particularly, various implementations of the invention provide a method for interpolating between test pattern features relative to layout features under test.

These and additional aspects of the invention will be further understood from the following detailed disclosure of illustrative embodiments.

### BRIEF DESCRIPTION OF THE DRAWINGS

The present invention will be described by way of illustrative embodiments shown in the accompanying drawings in which like references denote similar elements, and in which:

FIG. 1 illustrates an example computing environment;

FIG. 2 illustrates a mask feature;

FIG. 3 illustrates a layout design feature;

FIG. 3B illustrates the layout design feature of FIG. 3, shown in further detail;

FIG. 3C illustrates the portion of the layout design feature of FIG. 3B, shown in further detail;

FIG. 3D illustrates the layout design feature of FIG. 3, shown in further detail;

FIG. 3E illustrates the mask feature of FIG. 2, modified by an optical proximity correction process;

### DETAILED DESCRIPTION OF ILLUSTRATIVE EMBODIMENTS

The disclosed technology includes all novel and unobvious features, aspects, and embodiments of the systems and methods described herein, both alone and in various combinations and sub-combinations thereof. The disclosed features, aspects, and embodiments can be used alone or in various novel and unobvious combinations and sub-combinations with one another.

Although the operations of the disclosed methods are described in a particular sequential order for convenient presentation, it should be understood that this manner of description encompasses rearrangements, unless a particular ordering is required by specific language set forth below. For example, operations described sequentially may in some cases be rearranged or performed concurrently. Moreover, for the sake of simplicity, the disclosed flow charts and block diagrams typically do not show the various ways in which particular methods can be used in conjunction with other methods. Additionally, the detailed description sometimes uses terms like “determine” to describe the disclosed methods. Such terms are high-level abstractions of the actual operations that are performed. The actual operations that correspond to these terms will vary depending on the particular implementation and are readily discernible by one of ordinary skill in the art.

Some of the methods described herein can be implemented by software stored on a computer readable storage medium, or executed on a computer. Additionally, some of the disclosed methods may be implemented as part of a computer implemented electronic design automation (EDA) tool. The selected methods could be executed on a single computer or a computer networked with another computer or computers. For clarity, only those aspects of the software germane to these disclosed methods are described; product details well known in the art are omitted.

### Optical Proximity Correction Computing Environment

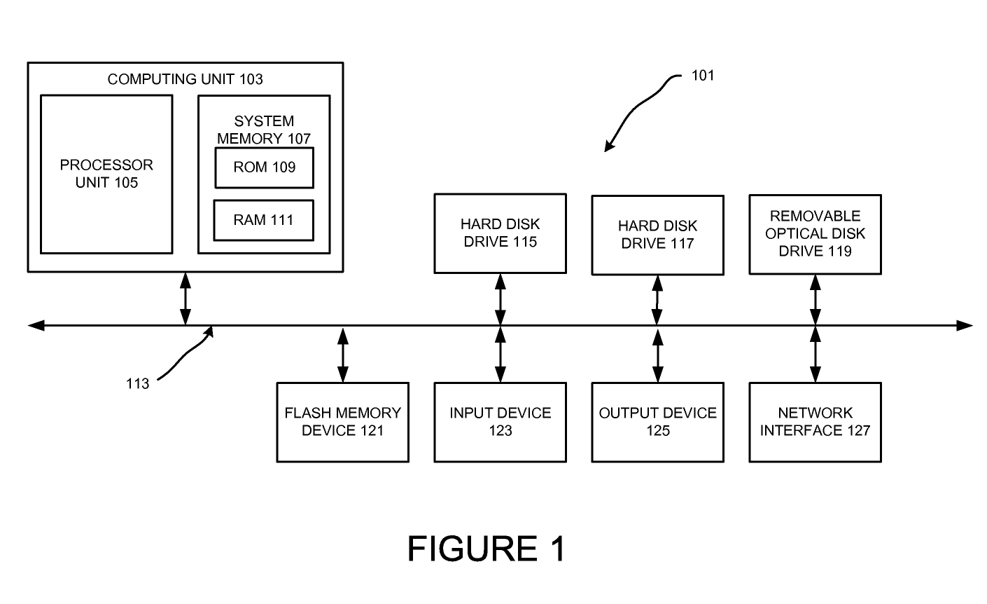

As described above, various examples of the invention may be implemented through the execution of software instructions by a computing device, such as a programmable computer. Accordingly, FIG. 1 illustrates an example of a computing device 101. As seen in this figure, the computing device 101 includes a computing unit 103 with a processing unit 105 and a system memory 107. The processing unit 105 may be any type of programmable electronic device for executing software instructions, but will conventionally be a microprocessor or a combination of two or more microprocessors. The system memory 107 may include both a read only memory (ROM) 109 and a random access memory (RAM) 111. As will be appreciated by those of ordinary skill in the art, both the read only memory 109 and the random access memory 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional memory storage devices, such as a fixed magnetic disk drive 115, a removable magnetic disk drive 117, an optical disk drive 119, or a flash memory device 121. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computing device 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (USB) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (TCP) or the Internet protocol (IP). Also, the network interface 127 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computer 101 is illustrated as an example only, and is not intended to be limiting. Various embodiments of the invention may be implemented using one or more computing devices that include the components of the computer 101 illustrated in FIG. 1, which include only a subset of the components illustrated in FIG. 1, or which include an alternate combination of components, including components that are not shown in FIG. 1. For example, various embodiments of the invention may be implemented using a multiprocessor computer, a plurality of single processor computers arranged into a network, a plurality of multiprocessor computers arranged into a network, or some combination of both.

### Optical Proximity Correction

In a photolithographic process, as explained above, electromagnetic radiation is transmitted through selectively transparent areas of a mask. The radiation passing through these transparent areas then irradiates desired portions of a photoreceptive material on a layer of semiconductor substrate. The mask in turn is created from layout design data describing the geometric features that should be manufactured on the semiconductor substrate, by way of the photolithographic process, in order to create the desired circuit. For example, if a transistor should have a rectangular gate region, then the layout design data will include a rectangle defining that gate region. This rectangle in the layout design data is then implemented in a mask for “printing” the rectangular gate region onto the substrate.

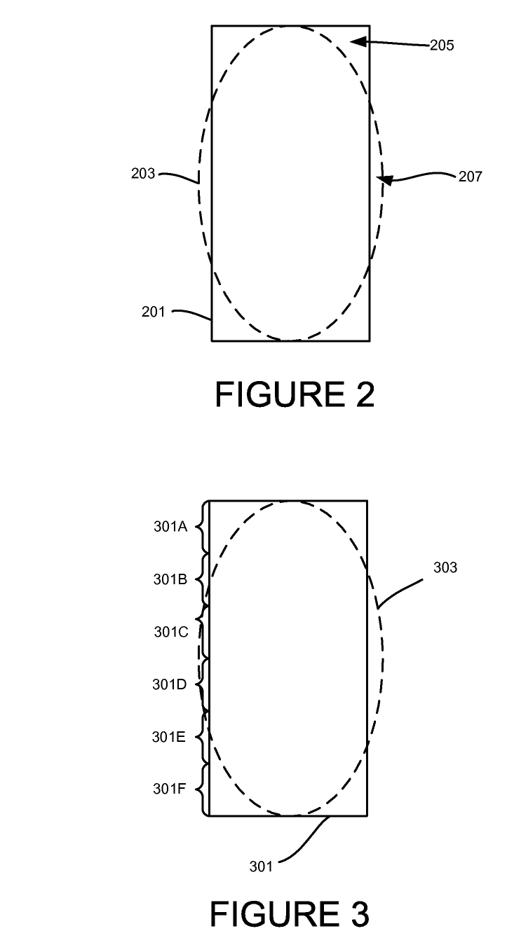

During a photolithographic process, however, optical effects will prevent the shapes defined by the mask from being faithfully imaged onto the substrate. Diffractive effects, for example, may distort the image produced by a mask. Moreover, these distortions become more pronounced as the images produced by the mask become smaller relative to the wavelength of radiation used in the photolithographic process. Thus, the rectangular mask feature 201 illustrated in FIG. 2 may produce only the image 203. As seen in this figure, the image 203 is substantially narrower in the corners (e.g., corner 205) than the ideal rectangular shape intended by the mask feature 201. Likewise, the image 203 may have areas (e.g., 207) that extend beyond the ideal rectangular shape intended by the mask feature 201. The intended shape or feature often is referred to as the target shape, or the target image. Ideally, the target image corresponds to the mask feature 201. The image created by employing the mask in a photolithographic process is often then referred to as the printed image.

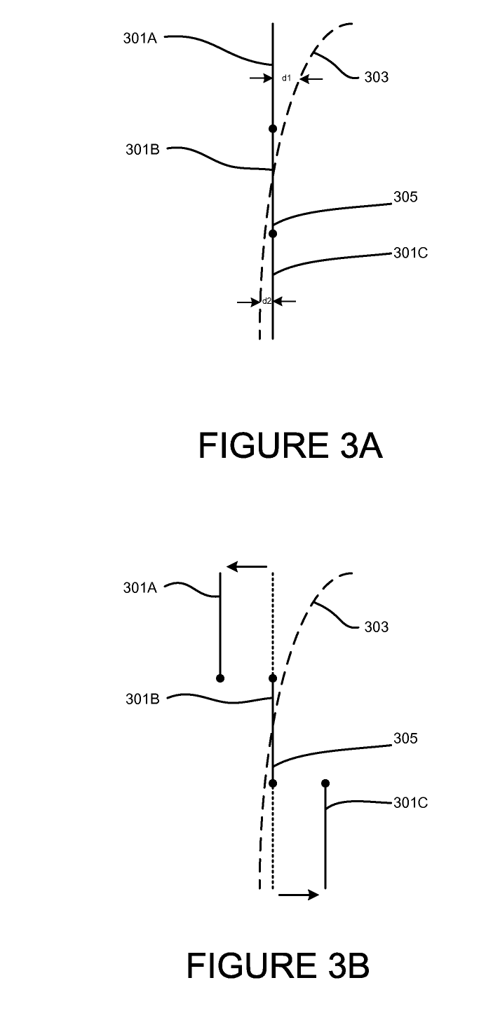

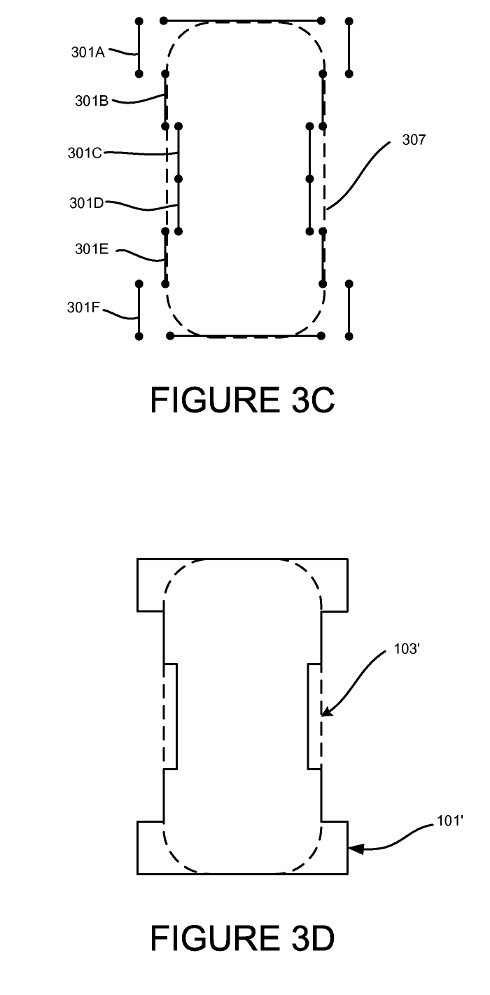

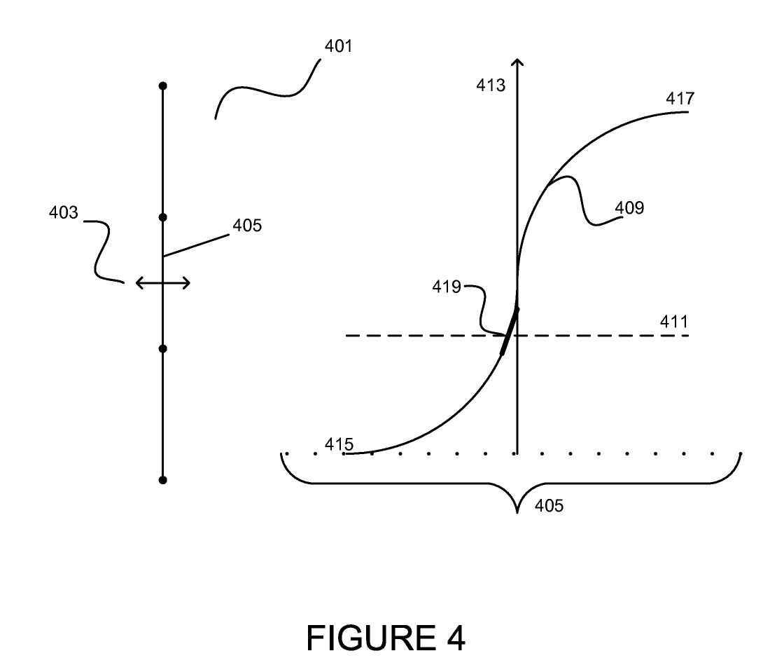

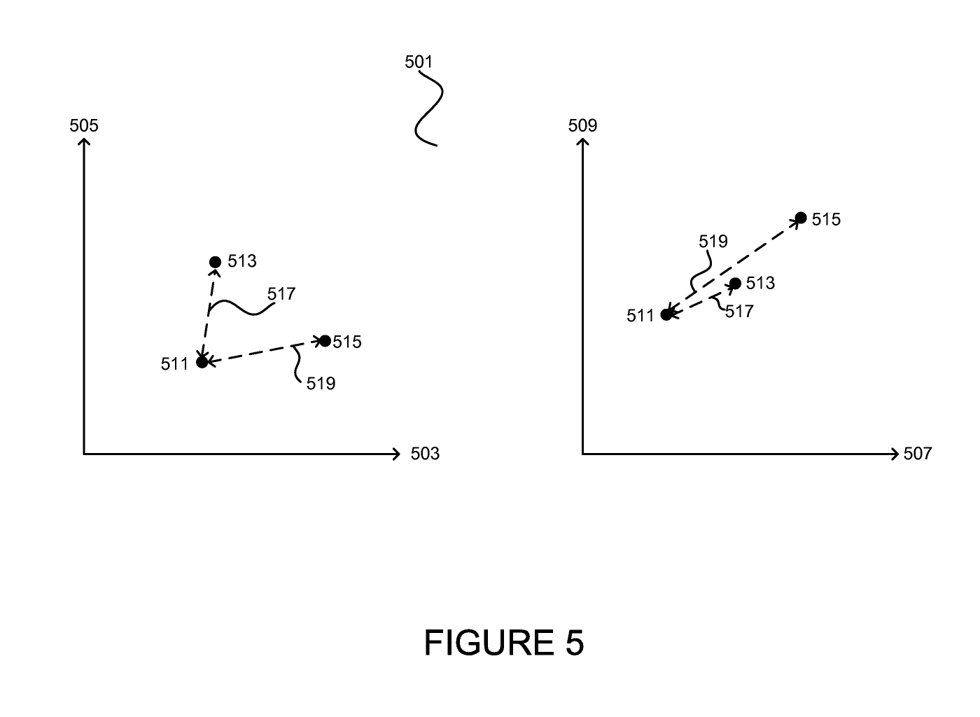

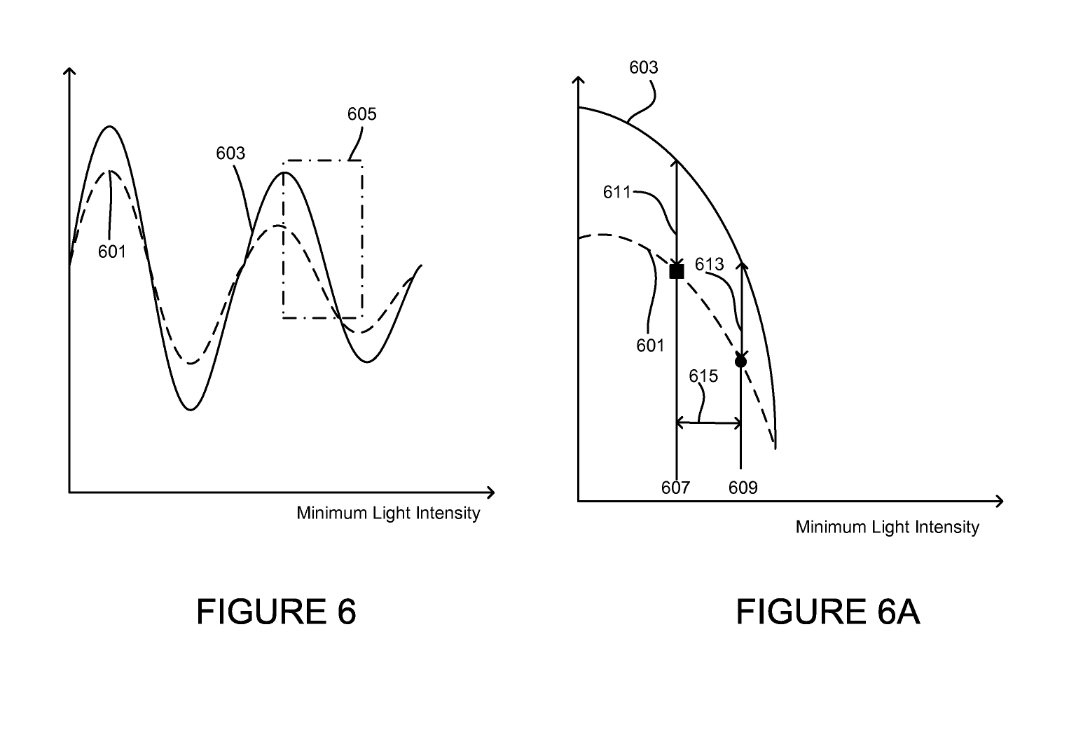

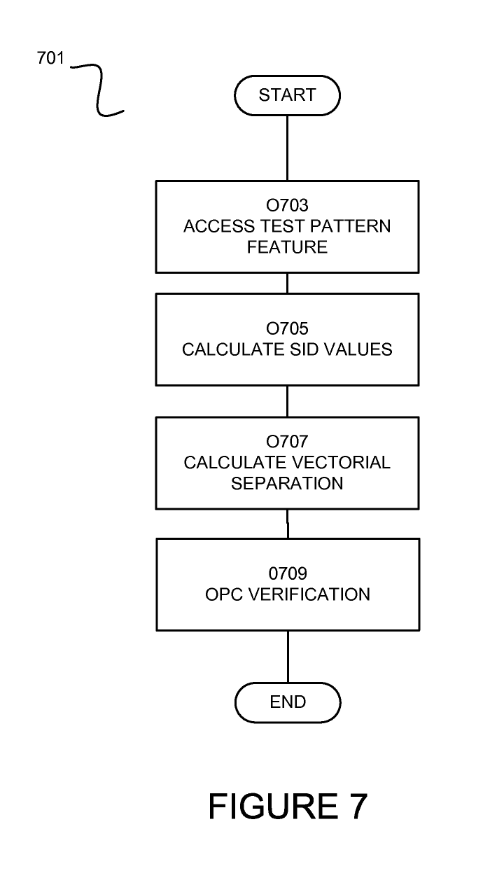

To correct for these optical distortions, many circuit designers will attempt to modify the layout design data, producing modified mask features, to enhance the resolution of the images that will be produced by the modified mask during the photolithographic process. Thus, some designers will employ an optical proximity correction (OPC) process on the layout design data, in an effort to better control the amplitude and phase of the radiation transmitted by the mask at specific locations. In a conventional optical proximity correction process, the edges of the geometric elements in the design are fragmented. For example, as shown in FIG. 3, an edge of the geometric element 301, which may be used to create the mask feature 201, is fragmented into edge segments 301A-301F. The partitioning of edge segments within a given layout design depends upon the specific optical proximity correction process parameters, often referred to as the optical proximity correction “recipe.” The recipe specifies, among other factors, the size of the edge segments. Accordingly, not all edges within a layout design will be fragmented in every optical proximity correction process. Additionally, the size of the edge segments resulting from fragmenting the polygon edges within a layout design can vary depending upon the layout design, the optical proximity correction process, or the optical proximity correction process recipe.

In attempting to correct for optical distortions within the photolithographic process, the optical proximity correction process simulates the printed image. That is, the photolithographic process is simulated in order to produce a simulated printed image. FIG. 3A illustrates a simulated printed image 303 and a target image 305, corresponding to a portion of the mask feature 301 of FIG. 3. This simulated image 303 is compared to the target image 305. Typically, this comparison is done at each edge segment. For example, as shown in FIG. 3A, the target image 305 is a distance d1 away from the simulated printed image 303 at the edge segment 301A, the target image 305 is a distance d2 away from the simulated printed image 303 at the edge segment 301C, while the target image 305 intersects the simulated printed image 303 at the edge segment 301B. The distances between the target image 305 and the simulated printed image 303 are often referred to as the edge placement error (EPE). Accordingly, in most conventional optical proximity correction processes, each edge segment, as well as each unfragmented edge, will have an associated edge placement error.

Next, the edge segments are individually moved in order to improve the resolution of the simulated printed image for the resulting mask. For example, as shown in FIG. 3B, the edge segment 301A is displaced in a direction away from the target image 305, in an effort to widen the corresponding portion of the image that would be produced by the resulting mask at the location of the edge segment 301A. Similarly, the edge segment 301C is displaced in a direction away from the target image 305, in an effort to narrow the corresponding portion of the image that would produced by the resulting mask at the location of the edge segment 301C. With various implementations of the invention, the displacement value will be a vector. More particularly, a displacement value will contain a distance component and a direction component.

This process of simulating the image that would be produced using the mask feature, comparing the simulated image to the target image, and moving edge segments accordingly may be repeated a number of times. Each cycle of simulation, compare, and move is referred to as an iteration of the optical proximity correction process. Typically, selecting edge segments to be moved during a given iteration, and the distance the edge segments are displaced, are determined based upon the edge placement errors for the edge fragment. For example, an optical proximity correction process may move an edge segment some factor of the edge placement error for that edge fragment away from the simulated printed image or the target image. Additionally, each edge segment may be displaced the same distance during a given iteration. The specific parameters that control edge movement are dependent upon the tool used to implement the optical proximity correction process and the optical proximity correction process recipe.

Typically, the optical proximity correction process is allowed to iterate until the simulated image is sufficiently similar to the target image (e.g., both d1 and d2 are smaller than a threshold value), or until it is determined that the edge segments have converged on locations where no further movement of the edge segments will improve the simulated image. FIG. 3C shows the geometric element 301 of FIG. 3, with the edges fragmented and displaced, along with a simulated printed image 307 based upon the displaced edge segments. Once the final positions of the edge segments are determined in the layout design data as shown in FIG. 3C, a modified mask feature can be created from the corrected layout design data. FIG. 3D shows a modified mask feature 101′, produced from the displaced edge segments of FIG. 3C. Additionally, the image 103′ produced by the modified mask feature 101′ is shown. FIG. 3D illustrates that the modified mask feature 101′ produces an image that more closely correspond to the target image.

As stated above, optical proximity correction is an iterative process. The number of iterations required for the process to converge on a suitable solution may be eight to ten iterations or more, depending upon the layout design and the “recipe”. Even with advanced computing resources, sophisticated optical proximity correction tools, and recipes that are tuned to the specific layout design, the time needed to perform eight to ten iterations is typically a few days.

### Optical Proximity Correction Models

As stated above, optical proximity correction is employed to improve the fidelity of the lithography process. However, modern lithography processes are extremely complicated, involving multiple physical and chemical operations throughout the process. As the lithography process is simulated during the optical proximity correction process, various models have been developed to assist in this simulation. Many of the lithography models employed in the optical proximity correction process model the light propagation and loading effects inherent to the lithography process. Various forms of models exist for performing optical proximity correction. For example, a set of models named VT5 Resist Models have been developed. The VT5 Resist Models are discussed more fully in “New Process Models For OPC At Sub-90 nm Nodes,” Y. Granik et al., Proceedings of SPIE Vol. 5040, pp. 1166-1176, which article is incorporated entirely herein by reference. The model employed in the optical proximity correction process is often referred to as the process model.

The VT5 Resist models are semi-empirical models. The model assumes that each edge segment within a layout design is a simulation site. Accordingly, the optical image parameters are extracted from the light intensity profile calculated at each respective edge segment, or simulation site. At each simulation site, a number of control points are employed, at which points the light intensity values are calculated. FIG. 4 illustrates a polygon edge 401 and an example image parameter calculation at a simulation site 403 along the polygon edge 401. As can be seen in FIG. 4, the simulation site 403 is placed in the center of an edge segment 405. With various embodiments of the present invention, the optical image parameters may be calculated as follows. At the simulation site 405, a number of control points 407 are used to generate the slope 409. The slope 409 is typically generated by searching along the control points 405 within a range of one-half the wavelength (λ) of the illumination system, divided by the Numerical Aperture (NA) of the lens employed in the photolithographic process. A reference threshold 411 is then formed at a point along the slope 409. The light intensity values along the slope 409 are also calculated, as shown by the line 413. The following optical image parameters are calculated for each simulation site 403. A minimum light intensity value 415, a maximum light intensity value 417, and a first derivative of the intensity profile 419 calculated at the reference threshold 411. Additionally, a second derivative of the intensity profile (not shown) is calculated at the reference threshold 411. The four parameters, 415-419 form the image parameter space. With various implementations of the invention it is possible to graph the image parameter space in cartesian coordinates.

After the initial model calculations illustrated in FIG. 4, the model, such as the VT5 process model, will be calibrated by the use of a curve fitting process. Typically, the inputs to the curve fitting process will be based upon measurements obtained from the actual lithography process that is used in the specific microdevice fabrication facility for which the layout design is to be fabricated. For example, the final printing position of some test features may be used as the measurements. These test features would then be combined in one layout to form a test pattern. During the curve fitting process the equation coefficients are typically optimized to give the least root mean square (RMS) error to the calibration data.

As with any curve fitting process, abnormal measurements may lead to modeling abnormalities. As a result, a part of the model calibration process should filter the data for abnormalities. These abnormalities could be due to metrology flyers, noise, or other phenomena. Additionally, the measured data are typically weighted according to feature type and statistical variance. As discussed above, a layout design is composed of various geometric features or polygons. Given the fact that the numerous polygon shapes may differ in the way they modulate the light and eventually affect the resist printing threshold, the performance of the model at these structures has to be guaranteed as well. Therefore, the predictability or coverage of the model has to be characterized. More particularly, the model employed in the optical proximity correction process must have sufficient coverage over the various geometric features within the layout design such that the quality of the model is sufficient.

The image parameter space (IPS) range of a process model is the region at which a simulation of the lithography process is sufficiently accurate for the optical proximity correction process to converge upon a solution. The image parameter space region depends on the quality of the calibration data in the optical parameters space. For good VT5 process model coverage, the calibration data must be uniform and diverse in the image parameter space, to allow the model to mimic most of the structures that are possible in the design rules and that realistically could occur in the layout.

In addition to simulating the photolithographic process, process models are employed to detect errors within the layout design. For example, the VT5 process models may be used to detect bridging and pinching locations in the layout design. Additionally, the process models may be used during the optical proximity correction process for a certain layout design to determine the printing position of the polygons edges. Some process models have marginal prediction results, which can lead to edge segments not converging upon an optimal solution. As a result, the checks for errors such as a pinching or bridging error will be affected.

### Safe Interpolation Distance

With various implementations of the invention, a method of locating insufficient image parameter space coverage on calibration test patterns relative to the layout design is provided. As discussed above and shown in FIG. 3A, the edge placement error is the difference between the actual or simulated contour at an edge segment. The absolute difference between the actual edge placement error measured on the wafer and the simulated edge placement error is called the relative edge placement error. With various implementations of the invention, a safe interpolation distance is defined for a process model is defined as the distance away from a test pattern feature in the optical image parameter space, at which the prediction results of the VT5 process model are sufficiently accurate. FIG. 5 shows graph of the image parameter space 501 for a layout design. The image parameter space 501 includes the minimum light intensity 503, the maximum light intensity 505, the slope 507, and the factor 509. As can be seen in FIG. 5, the image parameter space 501 also includes a test pattern point 511, a first design point 513 and a second design point 515. In various implementations of the invention, the distance 517 between the test pattern point 511 and the first design point 513 is calculated. Additionally, the distance 519 between the test pattern point 511 and the second design point 515 is calculated. Distances 517 or 519 that fall within the safe interpolation distance for the test pattern point 511 indicates that the particular features represented by that design point are covered by the process model. Distances 517 or 519 that fall outside the safe interpolation distance for the test pattern point 511 indicates that the particular features represented by that design point are not covered by the process model.

Various implementations of the invention employ the safe interpolation distance to detect inadequately covered locations in the design layout for calibrated test pattern configurations. Additionally, the quality of optical proximity correction verification test patterns may be increased by use of the safe interpolation distance. For example, a verification engineer may use a set of measured data for both model calibration and model verification. However, with various implementations of the invention, the confidence in the process model calibration for purposes of verification may be increased.

### The Safe Interpolation Distance Calculation

In various implementations of the invention, the safe interpolation distance is calculated by using the test pattern features as a sample design location, since their actual measurements form the lithographic process are available. FIG. 6 shows an actual edge placement error 601 along with a simulated edge placement error 603. The actual edge placement error 601 and the simulated edge placement error 603 are plotted against the minimum light intensity value. FIG. 6A shows the region 605 of FIG. 6 in greater detail. As can be seen in FIG. 6A, the actual edge placement error 601 and the simulated edge placement error 603 are shown. Additionally, a test pattern feature verification point 607 and a test pattern calibration point 609 are shown. Since the actual and simulated edge placement errors 601 and 603 for both the test pattern verification point 607 and the test pattern calibration point 609 are available, it is possible to calculate the relative edge placement error for both the test pattern verification point 607 and the test pattern calibration point 609. The distance 611 between the actual edge placement error 601 and the simulated edge placement error 603 at the test pattern verification point 607 (verification EPE) is found. Additionally, the distance 613 between the actual edge placement error 601 and the simulated edge placement error 603 at the test pattern calibration point 609 (calibration EPE) is also found. The change in the minimum light intensity 615 between the test pattern verification point 607 and the test pattern calibration point 611 also must be measured. Following which, the relative edge placement error (relative EPE) may be calculated by the following equation:

$${EPE}_{Relative} = \frac{{EPE}_{Verification} - {EPE}_{Calibration}}{Δ MinimumLightIntensity}$$

The safe interpolation distance for a specific test pattern point is defined as the distance at which the relative EPE exceeds a predetermined value. This predetermined value is defined for the various layout structures and layout designs individually. For example, a multiple layer design will typically have a different predetermined value than a single layer design.

With various implementations of the invention, the relative EPE variation of the closest test pattern feature (i.e. verification or calibration site) to a specific design layout location may be employed to estimate the value of the EPE relative for the design location (estimate EPE), which may be calculated by the following equation:

EPE_{Estimate}=EPE_{Calibration}+(EPE_{Relative}*ΔMinimumLightIntensity)

The safe interpolation distance for the specific test pattern then may be calculated as the product of the estimate EPE and a technology dependant constant. The technology dependant constant, similar to the predetermined value, is individual to the specific lithographic process and the manufacturing facilities.

As shown in FIGS. 6 and 6A, the safe interpolation distance is calculated with respect to the minimum light intensity value. With various implementations of the invention, the safe interpolation distance as applied to all the four optical image parameters, or the vectorial separation is given by:

V_{Separation}=\sqrt{(Δi min)²(Δi max)²(Δslope)²(Δfactor)²}

Where the variable representing each optical image parameter are calculated similar to the change in the minimum light intensity 615 between the test pattern verification point 607 and the test pattern calibration point 611, as shown in FIG. 6A. In various implementations of the present invention, the safe interpolation distance for each test pattern feature is calculated. These safe interpolation distance values are employed to judge the efficiency of the process model and determine when it has been sufficiently calibrated.

### Optical Proximity Correction Employing The Safe Interpolation Distance

In various implementations of the present invention, the safe interpolation distance values and the relative edge placement error variations for all the test pattern features are calculated and employed to detect the regions within a layout design that are covered by the process model, as well as the regions within the layout design that are not covered by the process model. FIG. 7 shows a method 701 that may be implemented according to various implementations of the present invention to detect the covered and uncovered regions within a layout design.

As can be seen in FIG. 7, the process 701 includes an operation 703 for accessing a test pattern feature within the layout design. In various implementations of the invention, the test pattern features accessed will be the nearest test pattern feature to the design layout point under test. The method 701 further includes an operation 705 for calculating the safe interpolation distance of the test pattern feature and an operation 707 for calculating the vectorial separation of the design layout point under test. Finally, the method 701 includes an operation for comparing the vectorial separation to the safe interpolation distance. With some implementations of the invention, if the vectorial separation is greater than the safe interpolation distance, the design layout point under test will be assumed covered by the process model. In other implementations of the invention, if the vectorial separation is some factor greater than the safe interpolation distance, it will be assumed that the design layout point under test is covered by the process model.

### CONCLUSION

Although certain devices and methods have been described above in terms of the illustrative embodiments, the person of ordinary skill in the art will recognize that other embodiments, examples, substitutions, modification and alterations are possible. It is intended that the following claims cover such other embodiments, examples, substitutions, modifications and alterations within the spirit and scope of the claims.

Various implementations of the present invention provide a method of determining is a optical proximity correction process model sufficiently covered the layout design. More particularly, various implementations of the invention provide a method for interpolating between test pattern features relative to layout design features under test.

What is claimed is:

1. A method for calibrating an optical proximity correction process model comprising:
accessing a layout design;
selecting a test point within the layout design;
accessing a test pattern associated with the layout design;
determining a vectorial separation for the test point;
determining a safe interpolation distance for the test pattern;
further calibrating the model based upon the safe interpolation distance and the vectorial separation;
